(19) United States
(12) Patent Application Publication
(10) Pub. No.: US 2012/0251782 A1
(43) Pub. Date: Oct. 4, 2012

(54) Injection molding method and component

(76) Inventors: Karsten HORST, Filderstadt (DE); Ulf Behnke, Reutlingen (DE); Jeanine Wegner, Reutlingen (DE)

(21) Appl. No.: 13/432,430

(22) Filed: Mar. 28, 2012

(30) Foreign Application Priority Data
Mar. 30, 2011 (DE) 10 2011 006 438.9
Mar. 8, 2012 (DE) 10 2012 203 636.9

(51) Int. Cl. B29C 45/14; B32B 3/30

(52) U.S. Cl. 428/156; 264/267

(57) ABSTRACT

An injection molding method is described, in which a medium is injected into a recess in a body, and in which a force is applied to the body to deform the recess in order to produce an undercut, which mechanically retains the injected medium. Also described is a related component.

### RELATED APPLICATION INFORMATION

The present application claims priority to and the benefit of German patent application no. 10 2011 006 438.9, which was filed in Germany on Mar. 30, 2011, and German patent application no. 10 2012 203 636.9, which was filed in Germany on Mar. 8, 2012, the disclosures of which are incorporated herein by reference.

### FIELD OF THE INVENTION

The present invention relates to an injection molding method and a component.

### BACKGROUND INFORMATION

In the automotive industry, components, in particular sensors, for example for airbag systems, are mounted in different areas in the vehicle. As a rule, one of the requirements is that an unwanted transfer of material from the component surroundings into the component itself is to be prevented. In particular, seals having different properties are used for this purpose. A seal of this type is usually situated in a seal channel. To be able to ensure a tight seal even over a longer period of time, the seal should sit fixedly in the seal channel and should also not be able to become loose and fall out of the seal channel.

### SUMMARY OF THE INVENTION

An object of the exemplary embodiments and/or exemplary methods of the present invention may therefore be seen as specifying an injection molding method which enables the manufacture of a component having a securely fixed seal.

The object of the exemplary embodiments and/or exemplary methods of the present invention may also be seen as specifying a component which enables a secure fixing of a seal.

These objects are achieved with the aid of the subject matter of the descriptions herein. Advantageous embodiments are the subject of the further descriptions herein.

According to one aspect, an injection molding method is provided, in which a medium is injected into a recess in a body. A force is applied to be body to deform the recess so as to produce an undercut. This undercut then mechanically secures the injected medium. The force may be applied prior to and/or during and/or following the injection of the medium into the recess. Due to this secure mechanical fixation by way of the undercut, the medium is securely and advantageously fixed in place in the recess. The medium is thus unable to fall out of the recess. The undercut may be developed in such a way in particular that it establishes a mechanical grip.

According to a further aspect, a component is provided which includes a body. The body has a self-contained recess; furthermore, an undercut, which runs over the entire recess, is formed in the recess so as to mechanically grip a seal. An enclosed recess in the sense of the present invention means, in particular, that the recess has no beginning and no end, but instead is closed like a circle, the recess not necessarily having to have a circular shape. Due to the fact that an undercut is formed over the entire course of the recess, a seal situated in the recess is mechanically gripped over the entire course of the seal, so that the seal is advantageously fixed particularly securely in the recess. The component and/or the seal may be manufactured with the aid of the injection molding method, in particular.

According to one specific embodiment, the component includes a sensor, in particular an airbag sensor. The body may be formed as a housing, the sensor being situated in an interior of the housing. The housing may thus also be referred to as sensor housing. According to one specific embodiment, multiple sensors may also be provided. The sensors may have different or identical designs. In the housing, the sensor is particularly reliably protected against external influences, for example moisture, due to the secure and permanent fixing of the seal.

According to one specific embodiment, a mold cavity is pressed onto the body to apply the force. With the aid of a mold cavity, it is possible, in particular, to apply the force to particular areas of the body according to the requirements. The mold cavity is usually shaped according to the geometry of the body and has, for example, recesses which correspond, in particular, to a connector or a fixing means of the body.

According to another specific embodiment, the recess is a seal channel. In particular, the seal channel is self-contained. This means that, similar to a circle or an ellipsis, the seal channel has no beginning and no end, the geometry of the seal channel not being intended to be limited exclusively to a circle or an ellipsis. In particular, the medium forms a seal which is held or fixed securely in the seal channel with the aid of the deformed area, for example the undercut.

According to a further specific embodiment, the medium is a thermoplastic elastomer (TPE). TPE, in particular, has a high temperature resistance and high weathering stability, so that the TPE seal provides a reliable sealing function even in harsh operating environments. In particular, sealing of a wet area from a dry area is provided by means of the seal, which may be the TPE seal. Moreover, a flow property of TPE may be set in such a way that the step of injecting the TPE into the recess may easily be regulated according to the requirements.

In another specific embodiment, the medium is injected into the recess at an injection pressure between 450 bar and 530 bar. This pressure range produces a particularly fast and therefore cost-effective injection, since it saves time, so that a corresponding component may be manufactured particularly cost-effectively. The medium may be injected for a time period of approximately 0.5 seconds to 1 second, in particular 0.65 second.

According to another specific embodiment, the body is formed by injecting another medium into a body mold cavity, in particular at an injection pressure of 750 bar to 880 bar. A method of this type may also be referred to as a 2C injection molding method. Here, “2C” stands for “two components”, i.e., a first component relating to the medium and a second component relating to the additional medium. In particular, the first component may be a hard component such as plastic. This means that a plastic may be injected into the body mold cavity. In this context, the second component may be referred to as a soft component, in particular if TPE is injected into the recess. A component made of two different materials, in particular one hard material and one soft material, may thus be advantageously manufactured in a die which includes, in particular, the body mold cavity. A 2C injection molding method of this type is particularly suitable for series production of a high volume of complex components, especially components having a housing. It may be ensured that the two materials have sufficient form stability prior to removing the body mold cavity from the body. For example, a predefined drying time may be observed before the body mold cavity is removed. Form stability is achievable in particular by a curing process. That means that the two materials age-harden. Once both materials have hardened, the body mold cavity is then removed from the first body, in particular. In general, the second medium is still sufficiently moldable when the medium is injected into the cavity, so that a deformation of the recess is able to be brought about in an especially uncomplicated manner.

The exemplary embodiments and/or exemplary methods of the present invention are explained in greater detail below on the basis of preferred exemplary embodiments with reference to the figures. The same reference numerals are used below for the same features.

### BRIEF DESCRIPTION OF THE DRAWINGS

FIG. 1 shows a flow chart of an injection molding method.

FIG. 2 shows a flow chart of a different injection molding method.

FIG. 3 shows a component.

FIG. 4 shows a seal channel according to the related art.

FIG. 5 shows a seal channel according to the present invention.

FIG. 6 shows a known component.

FIG. 7 shows a component according to the present invention.

FIG. 8 shows a mold cavity.

FIG. 9 shows the mold cavity from FIG. 8.

FIG. 10 shows a technical design drawing of a component according to the present invention.

FIG. 11 shows a cross section of the component.

FIG. 12 shows the component on a vehicle door.

FIG. 13 shows a collision between two vehicles.

### DETAILED DESCRIPTION

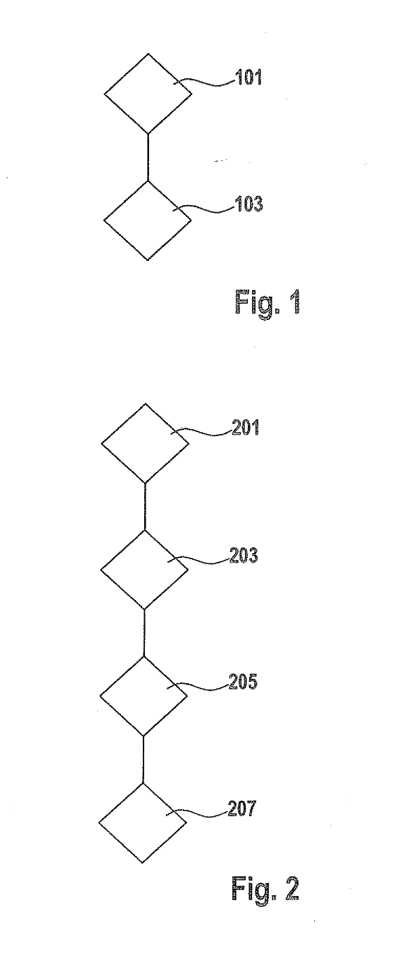

FIG. 1 shows a flow chart of an injection molding method. In a step 101, a medium is injected into a recess in a body, a force being applied to the body according to a step 103 to deform the recess, so that an undercut is produced which retains the medium mechanically. The force may be applied prior to and/or during and/or following the injection of the medium into the recess.

FIG. 2 shows a flow chart of an injection molding method. In a step 201, a hard component such as a plastic, is injected into a body mold cavity. The body mold cavity is a negative mold of the body to be formed. The body mold cavity thus reproduces a molding of the body which has one or multiple recesses, for example a seal channel.

In a step 203, a mold cavity is pressed onto the hard component, i.e., the body. The mold cavity is a negative mold of the shape to be created with the aid of the medium still to be injected such as a seal. The mold cavity thus specifies, in particular, a shaping of the seal.

In a step 205, the force applied to the hard component with the aid of the mold cavity is increased in such a way that the recess of the hard component deforms. In particular, a mechanical material structure of the hard component is compressed. Due to the compression of the hard component, for example, a previously vertical channel wall of the seal channel is deformed into a bulbous channel wall. Due to this targeted deformation, an undercut may be formed on the hard component without an additional mechanical slide of the injection molding die.

In a step 207, a medium such as TPE, is then injected into the recess, for example into the seal channel. During injection, the mold cavity remains pressed against the hard component, so that a force continues to be applied to the hard component during the medium injection process. The medium may continue to be injected into the recess, for example into the bulbous seal channel, until it completely fills the recess. This provides the medium, which may be, in particular, a seal, with a mechanical undercut. This undercut causes circumferential, mechanical gripping of the medium, in particular of the TPE seal, with the hard component. The medium, in particular the seal, is thus advantageously secured against falling out. In one exemplary embodiment, which is not shown, the force may be applied prior to and/or during and/or following the injection of the medium into the recess.

The use of TPE makes it possible to inject or mold the hard component and the soft component in a single working step, in particular, using a multi-component injection molding method, especially a 2C injection molding method. Thus, a structural integration onto the soft component into the thermoplastic component may advantageously be carried out in a fully automatic process without requiring an additional working step, for example dispensation of the seal. This achieves better cycle times, for example. Material consumption may also advantageously be reduced.

The connection between the hard component and the soft component or generally between the medium and the body is brought about by mechanically anchoring the materials, in particular with the aid of an undercut. No chemical reaction between the two materials has to take place for the purpose of forming an adhesive bond by chemical bonding between the hard component and the soft component, for example TPE.

During injection into the body mold cavity, the hard component may have a temperature between 270° C. and 290° C., in particular 270° C., which may be 275° C., for example 280° C., in particular 285° C. A temperature in the injection molding die may be between 80° C. and 100° C., in particular 83° C., for example 85° C. The soft component may have a temperature of 230° C. during injection. The mold cavity may be pressed onto the hard component at a pressure of 70 bar. According to one specific embodiment, an injection pressure of the hard component may be between 750 bar and 880 bar. The hard component may be injected into the body mold cavity for a period of several seconds, which may be one second, which may be 1.09 second. In particular, the soft component is injected into the recess, in particular at an injection pressure between 450 bar and 530 bar, for a time period of 0.5 seconds to several seconds, in particular 0.65 seconds. A cooling time in the first process step, i.e., during injection of the hard component, may be 8 seconds. A holding pressure time in the first process step is, for example, 7 seconds. A holding pressure time in a second process step, i.e., during injection of the soft component, is 1.6 seconds. An impact pressure in the first process step may be 35 bar. The injected component may be dried for 3 hours, in particular at a temperature of 120° C.

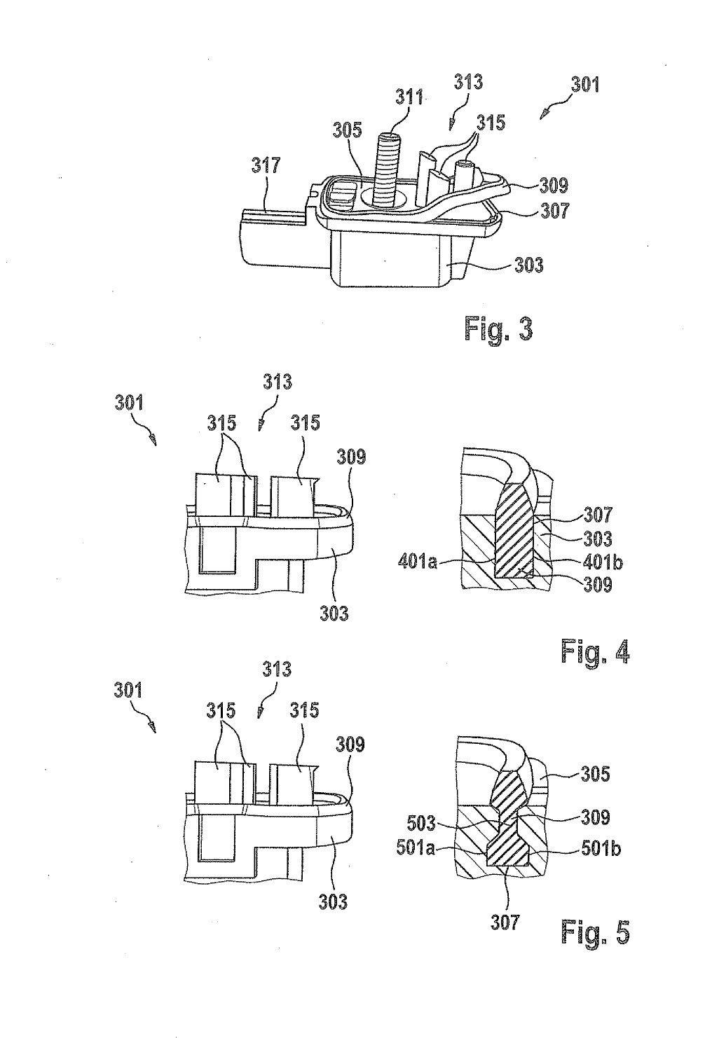

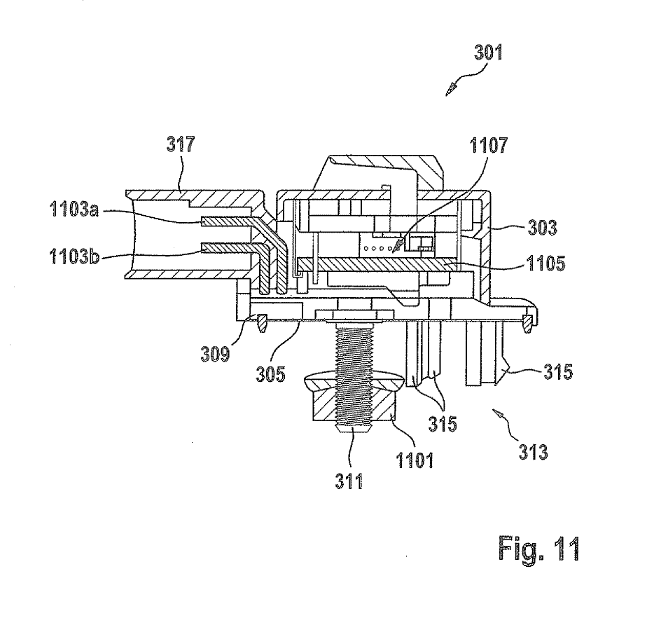

FIG. 3 shows a component 301. Component 301 has a body 303 which is provided as a housing. In particular, housing 303 is made of plastic. One or multiple sensor(s), in particular airbag sensors, may be situated in an interior (see FIG. 11) of housing 303. Housing 303 may thus also be referred to as a sensor housing. Housing 303 has a recess 307, which is provided as a seal channel, on an upper surface 305. Seal channel 307 is self-contained and therefore does not have an end and a beginning and thus at least partially encloses upper surface 305. A seal 309, which may be made of TPE, is situated in seal channel 307. Possible ways of fixing seal 309 in seal channel 307 are shown in FIG. 4 (according to the related art) and in FIG. 5 (according to the present invention).

Housing 303 has a fixing bolt 311, which includes an outer thread, on its upper surface 305. In particular, a threaded joint of the housing to a tapped bore (not illustrated) situated in a vehicle (not illustrated) is made possible with the aid of the fixing bolt. In addition, a mechanical anti-rotation element 313, which has three connector pins 315 is furthermore situated on upper surface 305. Using mechanical anti-rotation element 313, a mechanical anti-rotation protection is achieved in an affixation on the vehicle. In other words, housing 303 is mounted in a manner that prevents it from rotating and to that extent, is no longer able to be rotated in its affixation position. Housing 303 furthermore has a housing connector 317 to which, for example, control and/or data lines (not illustrated) may be connected, in particular to read the sensors.

FIG. 4 schematically shows a section of housing 303 in the left-hand drawing. The right-hand drawing in FIG. 4 shows a sectional view of seal channel 307. Seal channel 307 has vertical channel walls 401a and 401b, which run parallel to each other. No undercut is provided, so that no mechanical gripping of seal 309 is possible. Seal 309 is thus not securely fixed in seal channel 307 and as a result may easily fall out of seal channel 307.

Similar to FIG. 4, FIG. 5 schematically shows a section of housing 303 in the left-hand drawing. The right-hand drawing in FIG. 5 shows a sectional view of seal channel 307. Seal channel 307 has two vertical channel walls 501a and 501b which lie parallel to each other, channel walls 501a and 501b tapering bulbously in the direction of upper surface 305 so that seal channel 307 has a constriction 503. This constriction 503 is formed not only locally in a delimited area of seal channel 307 but runs circumferentially over the entire course of seal channel 307. A circumferential undercut is formed with the aid of this circumferential constriction 503, so that seal 309 is mechanically gripped or anchored over its entire course in seal channel 307. This advantageously makes it possible to fix seal 309 in place securely and to prevent seal 309 from falling out of seal channel 307. A component 301 having seal channel 307 illustrated in FIG. 5 is thus a component according to the present invention. A component of this type may be manufactured with the aid of the injection molding method according to the present invention.

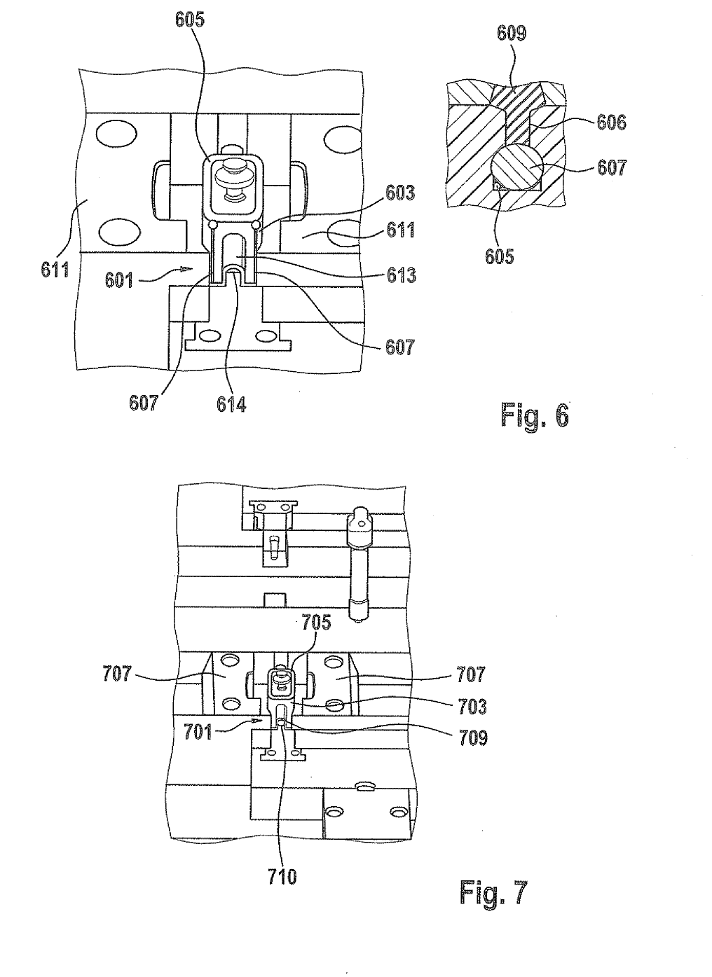

FIG. 6 shows a known component 601 having a housing 603 in the left-hand drawing. Housing 603 has a seal channel 605. A sectional view of seal channel 605 is illustrated in the right-hand drawing in FIG. 6. Two slides 607, which may also be referred to as slide pins, are provided for demolding an undercut 606 formed in seal channel 605. An undercut 606 may indeed be formed in seal channel 605 with the aid of slide pins 607. However, undercut 606 does not pass over the entire course of seal channel 605. A circumferential undercut 606 is thus not possible. This means that areas exist in seal channel 605 which do not have an undercut or constriction. A mechanical gripping of a seal 609 situated in seal channel 605 is thus not possible in these areas. As a result, seal 609 is not held securely in seal channel 605 and may thus easily fall out of the channel.

FIG. 6 furthermore shows two additional slides 611 for demolding housing 603 and one slide 614 for demolding a housing connector (not illustrated).

FIG. 7 shows a component 701 according to the present invention having a housing 703. Housing 703 has a seal channel 705. Here, too, similar to FIG. 6, two slides 707 for demolding housing 703 and one slide 710 for demolding a housing connector 709 are shown. Component 701 may be produced, in particular, by injecting plastic, for example, into slides 707 and 710 in a first process step.

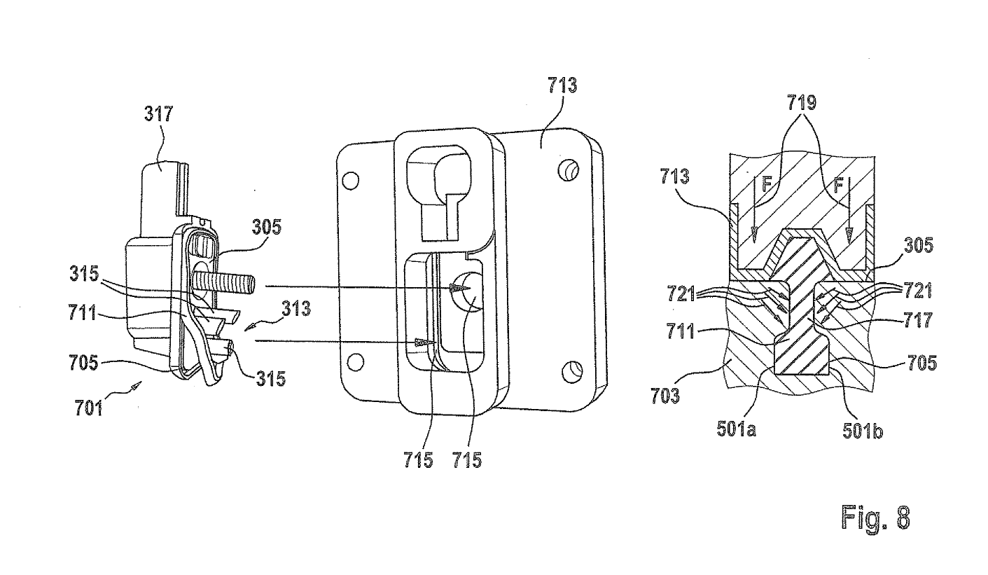

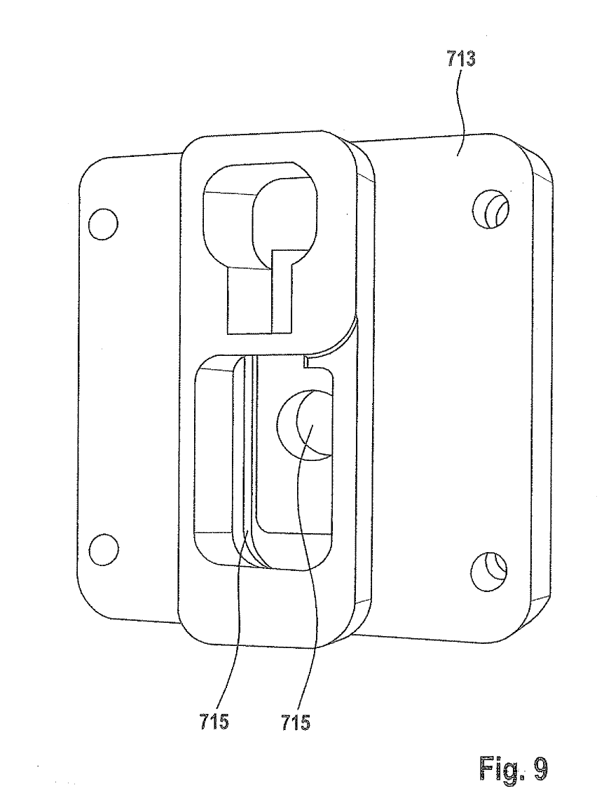

In a second process step, a seal 711 (see FIG. 8) is then injected into seal channel 705, for which a mold cavity 713 is used. FIG. 8 then shows, in the center drawing, mold cavity 713, which is formed similar to component 701 shown in the left-hand drawing, and which therefore has corresponding recesses 715. Component 701 has a similar construction as component 301 in FIGS. 3 and 5. To a certain extent, the same reference numerals may thus be used. Mold cavity 713 is shown again in FIG. 9.

The right-hand drawing in FIG. 8 shows a sectional view of seal channel 705, including injected seal 711. During the injection process, mold cavity 713 is pressed onto upper surface 305. A force F is thus applied to housing 703 which is set up in such a way that seal channel 705 deforms and a constriction 717 or undercut similar to seal channel 307 forms. Seal channel 705 is thus deformed due to the applied force. The pressing with the aid of mold cavity 713 or the application of a force is illustrated schematically with the aid of two arrows which have reference numeral 719. In particular, a mechanical material structure of housing 703 is thus compressed, which is illustrated with the aid of multiple arrows having reference numeral 721.

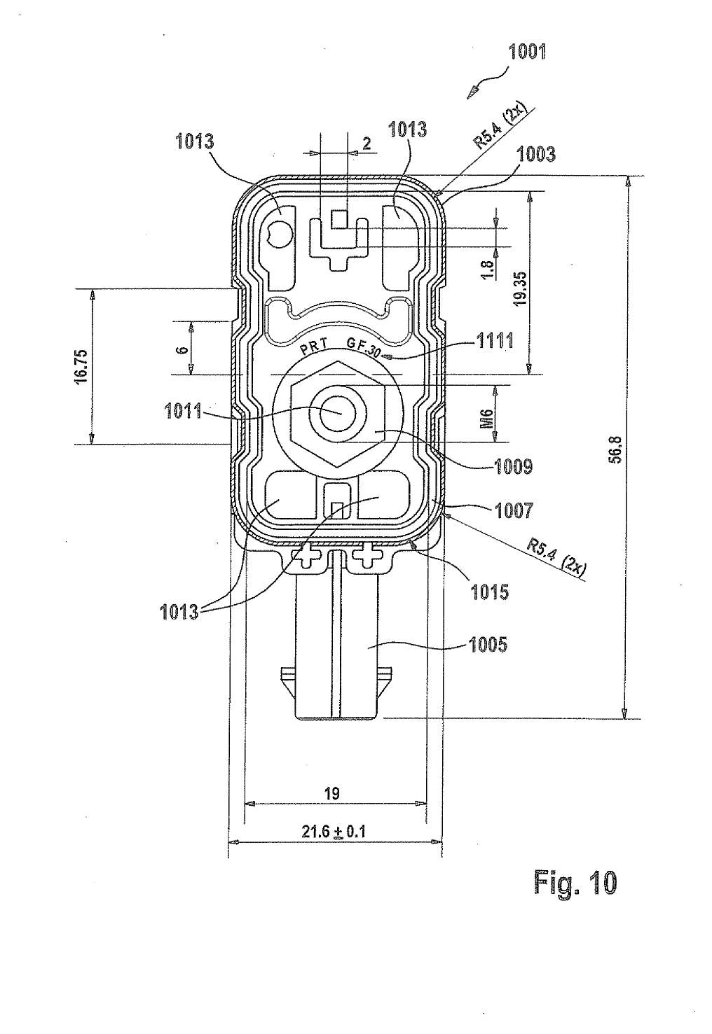

FIG. 10 shows a technical design drawing of a component 1001 according to the present invention having a housing 1003, viewed from a rear side of the housing. The plotted dimensions are understood to be only by way of example. It is clear to those skilled in the art that the dimensions may be changed depending on the requirements. A housing connector is identified by reference numeral 1005. A seal channel is identified by reference numeral 1007. A nut is identified by reference numeral 1009 and a bolt is identified by reference numeral 1011. The nut in this case is an M6 nut. However, other dimensions are also conceivable, for example an M4 nut or an M8 nut. A material indication “PRT GF.30,” which may be embossed onto the housing, for example, is identified by reference numeral 1111. Reference numeral 1013 identifies contact surfaces of housing 1003 during the manufacturing process. Seal channel 1007 may have one or multiple embossing zones 1015 which have, in particular, an embossing approximately 0.25 mm wide and a circumferential inner diameter of approximately 0.5 mm and a circumferential outer diameter of approximately 0.4 mm.

FIG. 11 shows a cross-section of housing 303. Reference numeral 1101 designates a nut that is screw-fitted with bolt 311 for the affixation of housing 303 on the vehicle. Reference numerals 1103a and 1103b designate individual pins for an electrical contacting of a circuit board 1105. Pins 1103a and 1103b are situated inside housing connector 317.

A sensor 1107, which may be configured as an airbag sensor, is situated on circuit board 1105. Sensor 1107 is electrically connected to circuit board 1105. Via the two pins 1103a and 1103b, electrical contacting and control of sensor 1107 are possible.

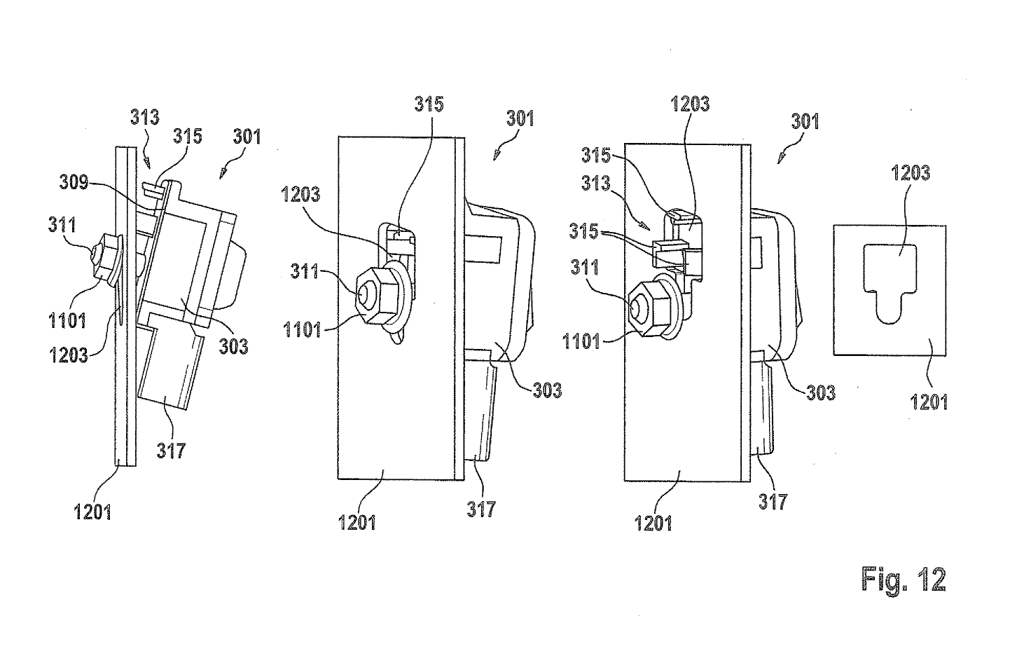

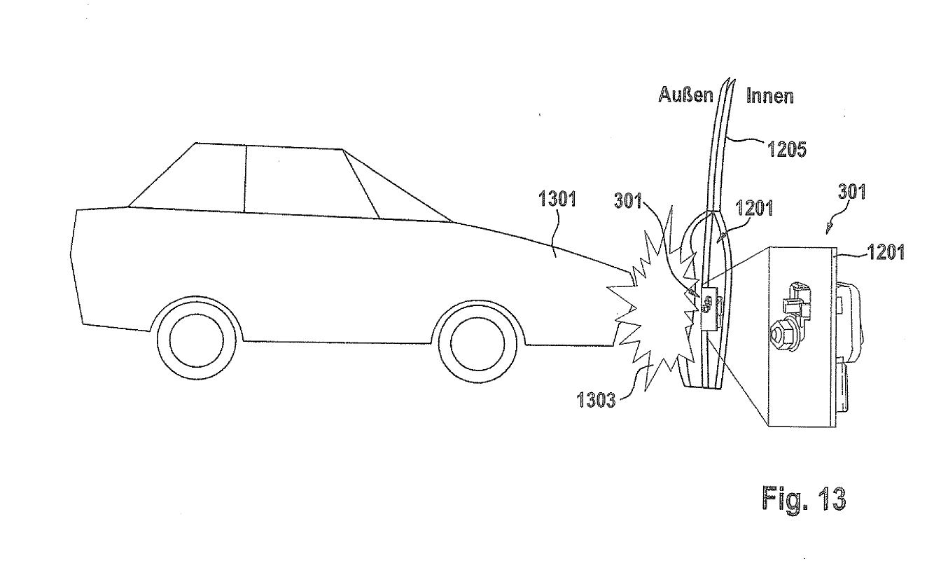

FIG. 12 shows different views of component 301 on a vehicle door 1201. Component 301 is inserted into a recess 1203 formed on vehicle door 1201 for affixation on vehicle door 1201; recess 1203 is formed in accordance with the geometry of mechanical anti-rotation protection 313. To this extent, the three connector pins 315 abut the edges of recess 1203, so that a rotation of component 301 is no longer possible. Once component 301 has been inserted into recess 1203, nut 1101 is screwed onto bolt 311 and then tightened. Seal 309 rests against an inner side 1205 (see FIG. 13) of vehicle door 1201 and seals an interior space delimited by vehicle door 1201 from an external environment or external space of the vehicle. The interior could also be called a dry area, and the external space a wet area.

FIG. 13 shows component 301 in vehicle door 1201 when another vehicle 1301 crashes into vehicle door 1201. This collision is symbolically illustrated by the jagged cloud bearing reference numeral 1303. Since seal channel 307 has an undercut, which may extend over the entire course of seal channel 307, seal 309 is mechanically held in seal channel 307 with the aid of the undercut in secure and reliable manner. As a result, reliable sealing of the interior from the exterior or the vehicle environment comes about. Sensor 1107 is therefore reliably protected from harmful external influences and thus operational. In other words, sensor 1107 may be able to detect the collision, whereupon suitable measures may then be taken. For instance, an airbag may be deployed.

What is claimed is:

1. An injection molding method, the method comprising:
injecting a medium into a recess in a body; and
applying a force to the body to deform the recess in order to produce an undercut, which mechanically retains the injected medium.

2. The injection molding method of claim 1, wherein a mold cavity is pressed onto the body to apply the force.

3. The injection molding method of claim 1, wherein the recess includes a seal channel.

4. The injection molding method of claim 1, wherein the medium includes a thermoplastic elastomer.

5. The injection molding method of claim 1, wherein the medium is injected into the recess at an injection pressure between 450 bar and 530 bar.

6. The injection molding method of claim 1, wherein the body is formed by an additional medium being injected into a body mold cavity.

7. The injection molding method of claim 6, wherein the additional medium is injected into the body mold cavity at an injection pressure between 750 bar and 880 bar.

8. A component, comprising:
a body which has a self-contained recess in which an undercut passing over the entire recess is formed to mechanically grip a seal.
